(19) United States
(12) Patent Application Publication
(10) Pub. No.: US 2022/0003298 A1
(43) Pub. Date: Jan. 6, 2022

(54) BALL SCREW DEVICE

(71) Applicant: JTEKT CORPORATION, Osaka (JP)

(72) Inventors: Ikuo YAMAMOTO, Kashiwara-shi (JP); Akiyoshi TASHIRO, Yamatotakada-shi (JP); Tomoya YAMATANI, Toyota-shi (JP)

(73) Assignee: JTEKT CORPORATION, Osaka (JP)

(21) Appl. No.: 17/360,514

(22) Filed: Jun. 28, 2021

(30) Foreign Application Priority Data
Jul. 1, 2020 (JP) 2020-114284

(51) Int. Cl. F16H 25/22

(52) U.S. Cl. CPC F16H 25/2219

(57) ABSTRACT

A nut includes a circulation passage such that balls are circulated through the circulation passage from a first axial end part of rolling raceway to a second axial end part of the rolling raceway. The nut includes a nut body, and end members connected to the opposite axial ends of the nut body. The nut body includes a first member and a second member. The first member includes a second spiral groove on the inner periphery of the first member and a passage having a groove shape opened radially outwardly, the passage being formed on the outer periphery of the first member such that the passage constitutes part of the circulation passage. The second member is placed radially outwardly from the first member and closes the passage from its radially outer side.

### CROSS-REFERENCE TO RELATED APPLICATION

This application claims priority to Japanese Patent Application No. 2020-114284 filed on Jul. 1, 2020, incorporated herein by reference in its entirety.

### BACKGROUND

### 1. Technical Field

The present disclosure relates to a ball screw device.

### 2. Description of Related Art

Japanese Unexamined Patent Application Publication No. 2004-84823 (JP 2004-84823 A) describes a ball screw device including: a threaded shaft including a first spiral groove formed on the outer periphery of the threaded shaft; a nut including a second spiral groove formed on the inner periphery of the nut so as to face the first spiral groove; and a plurality of balls disposed between the first spiral groove and the second spiral groove. The nut is constituted by a nut body and ring-shaped end members connected to the opposite axial ends of the nut body. The nut body has a first passage constituted by a through-hole penetrating the nut body in its axial direction, and each of the end members has a second passage formed from an axial end surface of the each of the end members to an inner peripheral surface of the each of the end members. A circulation passage is constituted by the first passage and the second passages such that the balls are circulated through the circulation passage from a first axial end part of the second spiral groove to a second axial end part of the second spiral groove.

### SUMMARY

The ball screw device described in JP 2004-84823 A requires machining such as cutting in order to form the first passage constituted by a through-hole inside the nut body. Particularly, in a case where the nut body includes a plurality of first passages, it is necessary to perform machining as many times as the number of the first passages. As a result, the manufacture of the nut body has become difficult, and the manufacturing cost of the ball screw device has increased.

The present disclosure provides a ball screw device that can reduce the manufacturing cost.

A ball screw device according to an aspect of the present disclosure includes a threaded shaft, a nut, and a plurality of balls. The threaded shaft includes a first spiral groove on the outer periphery of the threaded shaft. The nut is placed radially outwardly from the threaded shaft, and the nut includes a second spiral groove on the inner periphery of the nut so as to face the first spiral groove. The balls are placed on a rolling raceway formed between the first spiral groove and the second spiral groove. The nut includes a circulation passage such that the balls are circulated through the circulation passage from a first axial end part of the rolling raceway to a second axial end part of the rolling raceway. The nut includes a nut body, and end members connected to the opposite axial ends of the nut body. The nut body includes a first member and a second member. The first member includes the second spiral groove on the inner periphery of the first member and a passage having a groove shape opened radially outwardly. The passage is formed on the outer periphery of the first member such that the passage constitutes part of the circulation passage. The second member is placed radially outwardly from the first member and closes the passage from the radially outer side of the passage.

In the ball screw device having the above configuration, the nut body includes: the first member including the groove-shaped passage on the outer periphery of the first member; and the second member configured to close the passage from its radially outer side. Hereby, the passage of the first member can be formed by plastic working such as cold forging without performing machining such as cutting. Thus, the first member can be easily manufactured, and the manufacturing cost of the ball screw device can be reduced.

In the above aspect, the second member may be made of synthetic resin. With such a configuration, the nut body can be reduced in weight.

In the above aspect, the end members may be connected to the opposite axial ends of the first member by connectors and may project radially outwardly from the first member. The opposite axial end surfaces of the second member make contact with respective axial end surfaces of the end members on respective sides facing the second member. With such a configuration, only the first member in the nut body is connected to the end members by the connectors, and even if the second member is not connected to the end members by a connector, the second member can be positioned axially by the end members.

With the above aspect, it is possible to reduce the manufacturing cost of the ball screw device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a ball screw device according to one embodiment of the present disclosure;

FIG. 2 is a schematic sectional view of the ball screw device;

FIG. 3 is an exploded perspective view of the ball screw device;

FIG. 4 is an exploded perspective view illustrating a nut body and an end member in an enlarged manner;

FIG. 5 is a side view of the nut body; and

FIG. 6 is a side view of the end member.

### DETAILED DESCRIPTION OF EMBODIMENTS

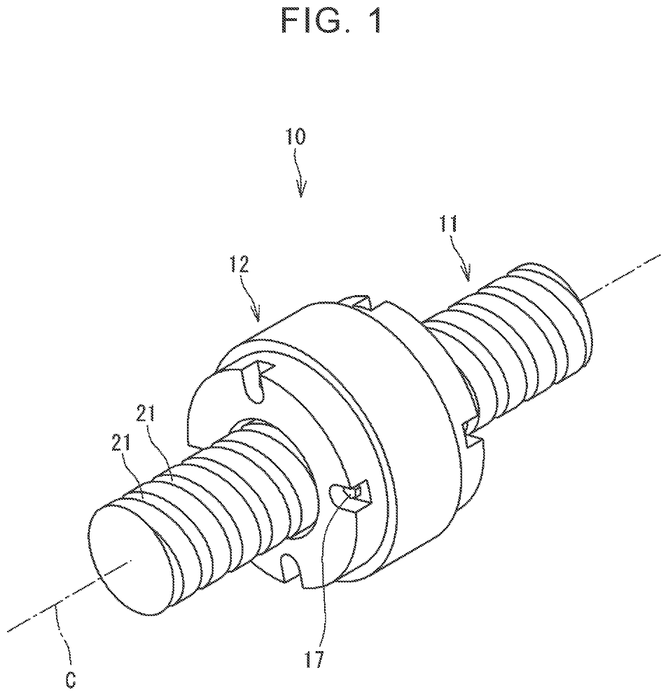

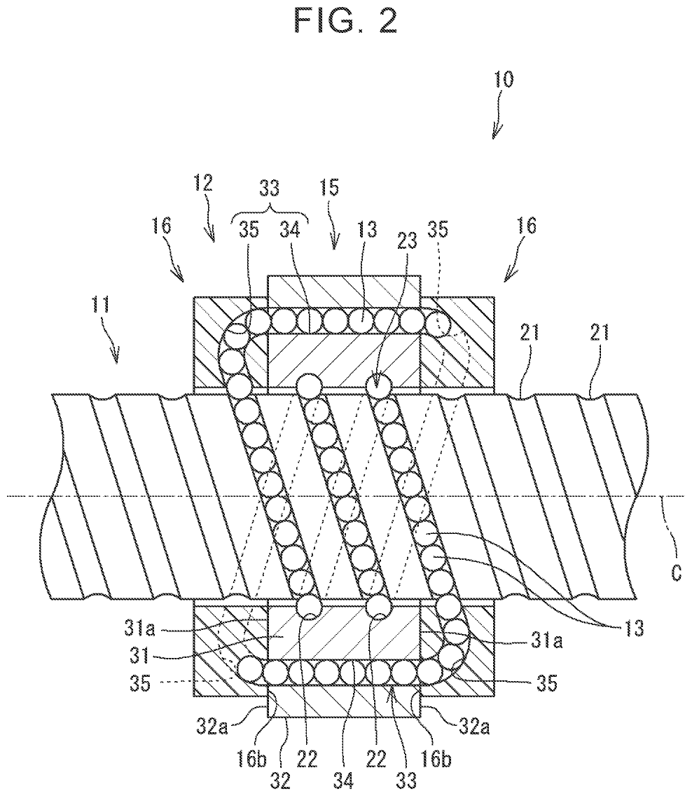

FIG. 1 is a perspective view of a ball screw device according to one embodiment of the present disclosure. FIG. 2 is a schematic sectional view of the ball screw device. As illustrated in FIGS. 1, 2, the ball screw device 10 of the present embodiment includes a threaded shaft 11, a nut 12, and a plurality of balls 13. The threaded shaft 11 is connected to a driving device such as a motor (not shown) such that the threaded shaft 11 is rotationally driven around its axial center C by the driving device. When the threaded shaft 11 is rotated, the nut 12 moves in a direction (an axial direction) along the axial center C of the threaded shaft 11.

The threaded shaft 11 is formed in a circular column shape. A first spiral groove 21 is formed on the outer periphery of the threaded shaft 11. The threaded shaft 11 of the present embodiment is a double thread screw (a multiple thread screw) in which two first spiral grooves 21 are arranged in parallel to each other along the axial direction. The threaded shaft 11 may be a single thread screw including one first spiral groove 21 or may be a multiple thread screw including three or more first spiral grooves 21.

The nut 12 is formed in a cylindrical shape. The nut 12 is placed radially outwardly from the threaded shaft 11. The axial center of the nut 12 coincides with the axial center C of the threaded shaft 11. A second spiral groove 22 is formed on the inner periphery of the nut 12. In the present embodiment, two second spiral grooves 22 are arranged in parallel to each other along the axial direction. The number of the second spiral grooves 22 to be formed is the same as the number of the first spiral grooves 21. The second spiral groove 22 is placed radially outwardly from the first spiral groove 21 and faces the first spiral groove 21. A rolling raceway 23 on which a ball 13 is rolled is formed between the first spiral groove 21 and the second spiral groove 22.

A plurality of balls 13 is placed between the first spiral groove 21 of the threaded shaft 11 and the second spiral groove 22 of the nut 12. When the threaded shaft 11 is rotated, the balls 13 roll on the rolling raceway 23 between the first spiral groove 21 and the second spiral groove 22 so as to give axial force to the nut 12, so that the nut 12 moves in the axial direction. The balls 13 pass through the rolling raceway 23 and a circulation passage 33 formed in the nut 12, so that the balls 13 are circulated from a first axial end part of the second spiral groove 22 of the nut 12 to a second axial end part thereof. Details of the circulation passage 33 will be described later.

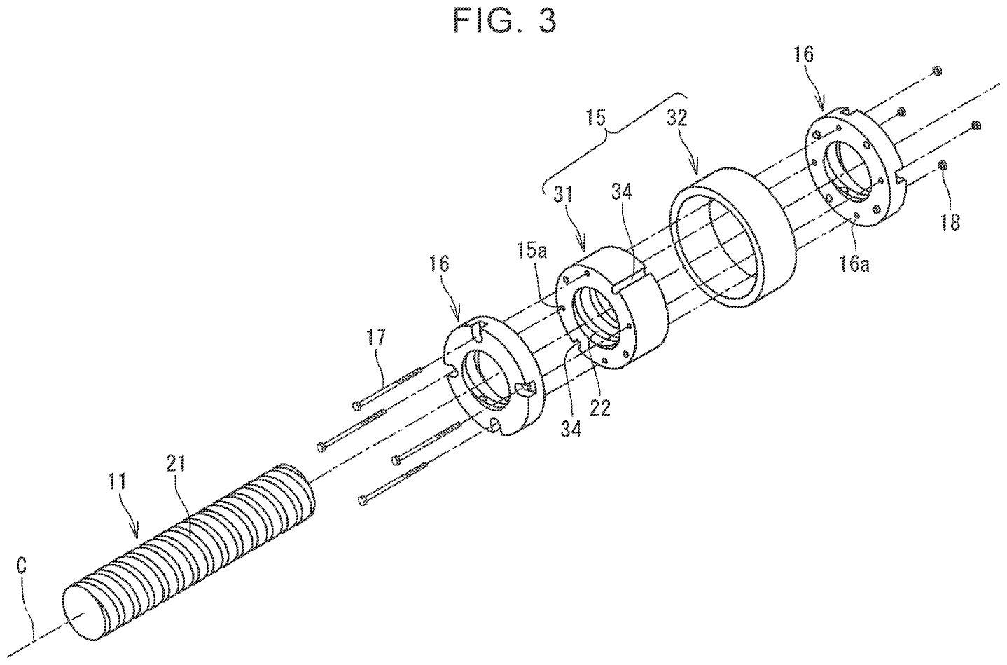

FIG. 3 is an exploded perspective view of the ball screw device 10. As illustrated in FIGS. 2, 3, the nut 12 includes a nut body 15 and two end members 16. The nut body 15 is formed in a cylindrical shape. The end members 16 are formed in a toric shape. As illustrated in FIG. 3, the end members 16 are connected to the opposite axial ends of the nut body 15 by bolts 17 and nuts 18. The nut body 15 and the end members 16 have insertion holes 15a, 16a through which the bolts 17 are passed.

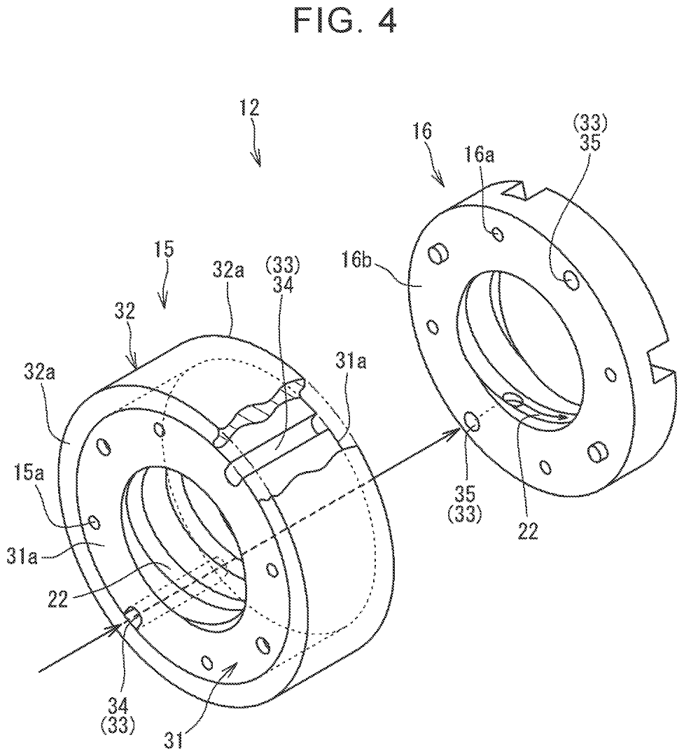

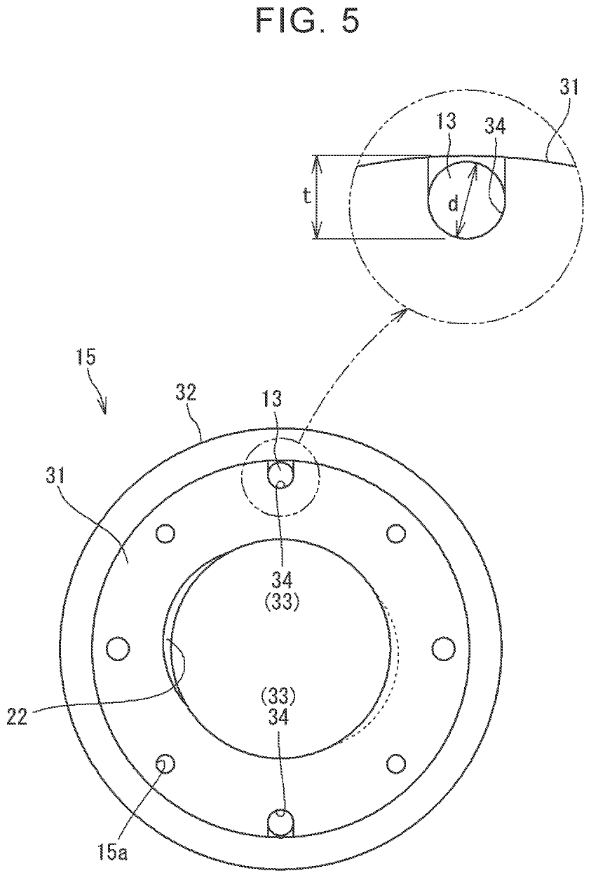

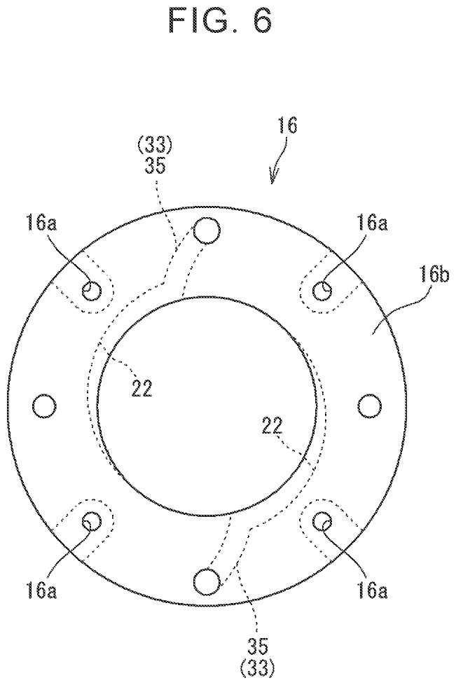

FIG. 4 is an exploded perspective view illustrating the nut body 15 and the end member 16 in an enlarged manner. FIG. 5 is a side view of the nut body 15. FIG. 6 is a side view of the end member 16. The nut body 15 includes a first member 31 and a second member 32. The first member 31 is made of metal. For example, the first member 31 can be made of chrome molybdenum steel. Note that the first member 31 may be made of other metallic materials. The first member 31 is formed in a cylindrical shape. Part of the second spiral groove 22 is formed on the inner periphery of the first member 31. A first passage 34 constituting part of the circulation passage 33 is formed on an outer peripheral surface of the first member 31.

Two first passages 34 are formed in respective parts the phases of which are separated by 180° on the outer periphery of the first member 31. The first passage 34 is formed in a linear shape along the axial direction between a first axial end surface 31a of the first member 31 and a second axial end surface 31a thereof. The first passage 34 is formed in a groove shape opened radially outwardly. As illustrated in FIG. 5, a groove bottom face of the first passage 34 curves in a U-shape. A radial length (groove depth) t of the first passage 34 is slightly larger than a diameter d of the ball 13.

Note that, in the present embodiment, the number of the first passages 34 in the first member 31 is two that is the same as the number of the spiral grooves 21, 22 (the number of threads thereof). However, the number of the first passages 34 may be formed larger than the number of the spiral grooves 21, 22. For example, three first passages 34 may be formed in respective parts the phases of which are separated by 120° on the outer periphery of the first member 31, or four first passages 34 may be formed in respective parts the phases of which are separated by 90° on the outer periphery of the first member 31. In a former case (a case where three first passages 34 are formed), the first member 31 is applicable to the ball screw device 10 with three spiral grooves 21, 22 and is also applicable to the ball screw device 10 with one spiral groove 21, 22. In a latter case (a case where four first passages 34 are formed), the first member 31 is applicable to the ball screw device 10 with four spiral grooves 21, 22 and is also applicable to the ball screw device 10 with one or two spiral grooves 21, 22. Accordingly, one type of the first member 31 is applicable to various types of the ball screw devices 10 with different numbers of the spiral grooves 21, 22.

The second member 32 is made of synthetic resin. For example, the second member 32 can be made of polyphenylene sulfide (PPS) resin. Note that the second member 32 may be made of other synthetic resin materials having high rigidity. The second member 32 is formed in a cylindrical shape. As illustrated in FIG. 3, an inner peripheral surface and an outer peripheral surface of the second member 32 are smoothly curved cylindrical surfaces without projections and recessions. The inside diameter of the second member 32 is generally the same as the outside diameter of the first member 31. The first member 31 and the second member 32 are connected to each other such that the first member 31 is fitted by pressing into the radially inner side of the second member 32. The first passages 34 of the first member 31 are closed by the second member 32 from the radially outer side. Accordingly, the second member 32 prevents the balls 13 placed inside the first passages 34 from leaving radially outwardly from the first passages 34.

The end member 16 is formed in a toric shape. The inside diameter of the end member 16 is the same as the inside diameter of the first member 31 of the nut body 15. The outside diameter of the end member 16 is larger than the outside diameter of the first member 31 and the inside diameter of the second member 32 but is smaller than the outside diameter of the second member 32. Part of the second spiral groove 22 is formed on the inner periphery of the end member 16.

As illustrated in FIG. 2, axial end surfaces 16b of the end members 16 make contact with the axial end surfaces 31a of the first member 31 and axial end surfaces 32a of the second member 32. As illustrated in FIGS. 3, 4, the end members 16 and the first member 31 have the insertion holes 16a, 15a through which the bolts 17 are passed, such that the end members 16 are connected to the first member 31 by the bolts 17 and the nuts 18.

On the other hand, the second member 32 is not connected to the end members 16, and as illustrated in FIG. 2, the second member 32 makes contact with the end surfaces 16b of the end members 16, the end surfaces 16b projecting radially outwardly from the first member 31. On this account, the second member 32 is sandwiched between the end members 16 from the opposite sides in the axial direction, so that the second member 32 is positioned in the axial direction.

As illustrated in FIGS. 2, 4, 6, a second passages 35 constituting part of the circulation passage 33 is formed in the end member 16. Two second passages 35 are formed in respective parts the phases of which are separated by 180° in the end member 16. First ends of the second passages 35 are opened on the end surface 16b of the end member 16 on a side facing the nut body 15 side, and second ends of the second passages 35 are opened in the second spiral grooves 22 on the inner periphery of the end member 16. The second passages 35 communicate with the first passages 34 of the nut body 15. The number of the second passages 35 to be formed is just the same as the number of the first passages 34. Thus, the circulation passage 33 communicates with a first axial end and a second axial end of the rolling raceway 23, so that the balls 13 are circulated between the first axial end and the second axial end.

As illustrated in FIG. 2, when the threaded shaft 11 is rotated around the axial center C, the balls 13 pass through the rolling raceway 23 formed between the first spiral groove 21 and the second spiral groove 22, then pass through the second passage 35 of one of the end members 16 of the nut 12, the first passage 34, and the second passage 35 of the other one of the end members 16, and return to the rolling raceway 23. The balls 13 repeat this operation. Hereby, the nut 12 moves along the axial center C of the threaded shaft 11 along with the movement of the balls 13.

The ball screw device 10 of the present embodiment described above includes: the threaded shaft 11 including the first spiral groove 21 formed on the outer periphery of the threaded shaft 11; the nut 12 placed radially outwardly from the threaded shaft 11, the nut 12 including the second spiral groove 22 formed on the inner periphery of the nut 12 so as to face the first spiral groove 21; and the balls 13 placed on the rolling raceway 23 formed between the first spiral groove 21 and the second spiral groove 22. The nut 12 includes the circulation passage 33 such that the balls 13 are circulated from a first axial end part of the rolling raceway 23 to a second axial end part of the rolling raceway 23. The nut 12 includes the nut body 15, and the end members 16 connected to the opposite axial ends of the nut body 15. The nut body 15 includes the first member 31 and the second member 32. The first member 31 including the second spiral groove 22 on the inner periphery of the first member 31 and the first passage 34 having a groove shape opened radially outwardly, the first passage 34 being formed on the outer periphery of the first member 31 such that the first passage 34 constitutes part of the circulation passage 33. The second member 32 is placed radially outwardly from the first member 31 and closes the first passage 34 from the radially outer side of the first passage 34. In such a configuration, differently from the related art (for example, see JP 2004-84823 A), it is not necessary to form a through-hole as the first passage in the nut body by machining such as cutting, and the first passage 34 of the first member 31 can be formed by plastic working such as cold forging. In a case where the number of threads of the spiral grooves 21, 22 of the ball screw device 10 is changed, the first member 31 corresponding to the number of threads of the spiral grooves 21, 22 can be formed by changing a metal die to be use for plastic working, and it is not necessary to increase the number of machining depending on the number of threads of the spiral grooves 21, 22. Hereby, the nut body 15 can be easily manufactured, and the manufacturing cost of the ball screw device 10 can be reduced.

The balls 13 just pass through the circulation passage 33 formed in the nut 12, and force to axially move the nut 12 is not given to the circulation passage 33. Accordingly, the strength to be required is lower than that of the rolling raceway 23. On this account, in the present embodiment, the second member 32 of the nut body 15 is made of synthetic resin the strength of which is lower than metal. Hereby, the nut body 15 can be reduced in weight.

The end members 16 of the nut 12 are connected to the opposite axial ends of the first member 31 by connectors constituted by the bolts 17 and the nuts 18. The end members 16 project radially outwardly from the first member 31. The opposite axial end surfaces 32a of the second member 32 of the nut body 15 make contact with the axial end surfaces 16b of the end members 16 on respective sides facing the second member 32. The nut body 15 of the present embodiment includes the first member 31 and the second member 32, and the number of components increases in comparison with the related art. However, only the first member 31 is connected to the end members 16 by the connectors 17, 18, and the second member 32 is just positioned axially by the end members 16. On this account, even when the nut body 15 is constituted by two members of the first member 31 and the second member 32, it is not necessary to increase the number of the connectors 17, 18 or the number of connected parts.

The embodiment described herein is just an example in all respects and is not limitative. That is, the ball screw device of the present disclosure is not limited to the embodiment illustrated in the drawings and may have other embodiments within the scope of the present disclosure. For example, the second member 32 of the nut body 15 may be made of metal. The second member 32 may be connected to the first member 31 or the end members 16 by use of a connector such as a bolt.

The connector configured to connect the first member 31 of the nut body 15 to the end members 16 may be, for example, a totally threaded shank screw called a head-cut bolt. In this case, internal-thread holes are formed in the nut body 15 and the end members 16 instead of the insertion holes 15a, 16a.

What is claimed is:

1. A ball screw device comprising:
a threaded shaft including a first spiral groove on an outer periphery of the threaded shaft;
a nut placed radially outwardly from the threaded shaft, the nut including a second spiral groove on an inner periphery of the nut so as to face the first spiral groove; and
a plurality of balls placed on a rolling raceway formed between the first spiral groove and the second spiral groove, wherein:
the nut includes a circulation passage such that the balls are circulated through the circulation passage from a first axial end part of the rolling raceway to a second axial end part of the rolling raceway;
the nut includes a nut body, and end members connected to opposite axial ends of the nut body; and
the nut body includes a first member and a second member,
the first member including the second spiral groove on an inner periphery of the first member and a passage having a groove shape opened radially outwardly, the passage being formed on an outer periphery of the first member such that the passage constitutes part of the circulation passage,
the second member being placed radially outwardly from the first member and closing the passage from a radially outer side of the passage.

2. The ball screw device according to claim 1, wherein the second member is made of synthetic resin.

3. The ball screw device according to claim 2, wherein:
the end members are connected to opposite axial ends of the first member by connectors and project radially outwardly from the first member; and
opposite axial end surfaces of the second member make contact with respective axial end surfaces of the end members on respective sides facing the second member.

4. The ball screw device according to claim 1, wherein:
the end members are connected to opposite axial ends of the first member by connectors and project radially outwardly from the first member; and
opposite axial end surfaces of the second member make contact with respective axial end surfaces of the end members on respective sides facing the second member.
